(19) United States
(12) Patent Application Publication
(10) Pub. No.: US 2018/0199661 A1
(43) Pub. Date: Jul. 19, 2018

(54) METHOD FOR MANUFACTURING A MASSAGING SHOE

(71) Applicant: SHENZHEN BREO TECHNOLOGY CO., LTD., Shenzhen (CN)

(72) Inventors: Xuejun MA, Shenzhen (CN); Chuanle JIANG, Shenzhen (CN); Daming YU, Shenzhen (CN); Huchen ZHAO, Shenzhen (CN)

(21) Appl. No.: 15/121,685

(22) PCT Filed: Jun. 29, 2016
(86) PCT No.: PCT/CN2016/087633

§ 371 Date: Aug. 25, 2016

(30) Foreign Application Priority Data
Jun. 3, 2016 (CN) 201610393401.7

(51) Int. Cl. A43B 7/00; A61H 9/00; A43B 3/00; A43B 17/00; A61H 39/04; A43B 13/20; A43D 25/20

(52) U.S. Cl. CPC A43B 7/00; A61H 9/0078; A43B 3/0063; A43B 17/00; A61H 39/04; A61H 2201/1695; A43D 25/20; A61H 2201/0103; A61H 2201/1238; A61H 2201/165; A43B 13/203

(57) ABSTRACT

A method for manufacturing a massaging shoe comprises: during the manufacture, preparing a shoe sole (10) firstly, wherein the shoe sole (10) includes a shoe sole body (11) having a containing cavity and a top board (12) arranged on the shoe sole body (11), and a controlling element assembly (60) is arranged in the containing cavity; preparing a shoe vamp (20), wherein an inner side of the shoe vamp (20) is provided with an interlayer; preparing a first massaging air bag (30), a second massaging air bag (40), and a third massaging air bag (50); securing the shoe vamp (20) onto the shoe sole (10) to form a sole body, arranging the second massaging air bag (40) on the top board (12) in the shoe body, arranging the first massaging air bag (30) and the third massaging air bag (50) in the interlayer of the shoe vamp (20), and communicating the three massaging air bags with the controlling element assembly (60). In the method of the present invention, when assembly the shoe vamp (20) and the shoe sole (10), since there is no massaging air bag in the shoe vamp (20), the assembly between the shoe vamp (20) and the shoe sole (10) is more convenient and easier, such that the manufacturing process of the massaging shoe is simplified, and the massaging air bag is prevented from being damaged, thereby improving the yield rate; moreover, both assembly and disassembly of the massaging air bag are convenient, and it is also convenient to clean and repair the massaging shoe.

### FIELD OF THE INVENTION

The present invention relates to the technical field of massagers, and more particularly relates to a massaging shoe and a method for manufacturing the same.

### BACKGROUND OF THE INVENTION

There are various massaging shoes on the market. Most massaging shoes are made by assembling many independent components. Thus, the process is complicated, the machining efficiency is low, and the producing cost is high; furthermore, these massaging shoes are difficult to be cleaned and repaired.

### SUMMARY OF THE INVENTION

A purpose of the present invention is to provide a method for manufacturing a massaging shoe, which aims at solving the problem in the prior art that a process of manufacturing massaging shoes is complicated, a machining efficiency is low, and producing cost is high.

In order to solve the aforementioned technical problems, the present invention provides the following technical solution.

A method for manufacturing a massaging shoe is provided, and the method comprises the following steps:

a preparing step:

preparing a shoe sole, wherein the shoe sole includes a shoe sole body having a containing cavity, a top board arranged on the shoe sole body, and a bottom board arranged at a bottom part of the shoe sole body; when preparing the shoe sole, the top board covers on the containing cavity, and a controlling element assembly is arranged in the containing cavity;

preparing a shoe vamp, wherein an inner side of the shoe vamp is provided with an interlayer; and

preparing a first massaging air bag configured to massage an instep, a second massaging air bag configured to massage a foot sole, and a third massaging air bag configured to massage a heel;

an assembling step:

securing the shoe vamp onto the shoe sole to form a sole body, arranging the second massaging air bag on the top board in the shoe body, arranging the first massaging air bag and the third massaging air bag in the interlayer of the shoe vamp, communicating the first massaging air bag, the second massaging air bag, and the third massaging air bag with the controlling element assembly, and finally fixing the bottom board at the bottom part of the shoe sole body.

Particularly, when preparing the shoe sole, the top board is fixed above the containing cavity of the shoe sole body firstly, and the controlling element assembly is mounted in the containing cavity; in the assembling step, after the first massaging air bag, the second massaging air bag, and the third massaging air bag are communicated with the controlling element assembly, the bottom board is fixed at the bottom part of the containing cavity.

Particularly, when preparing the shoe vamp, a connecting element enabling an opening of the interlayer to be in an opened status or a closed status is arranged at the opening of the interlayer.

Particularly, the connecting element is any one of a zipper, a fastener, and a velcro.

Particularly, the controlling element assembly includes an air pump, an air pipe communicated with the air pump, and a controlling valve controlling the air pump; when preparing the top board, a plurality of assembly openings enabling nozzles to extend into the containing cavity and communicate with the air pipe are arranged on the top board.

Particularly, in the assembling step, the shoe vamp is secured onto the shoe sole using adhesive and by a hot melt method.

Particularly, in the assembling step, after the first massaging air bag, the second massaging air bag, and the third massaging air bag are arranged in the shoe body, a nozzle of the first massaging air bag, a nozzle of the second massaging air bag, and a nozzle of the third massaging air bag are respectively inserted into the containing cavity through the assembly openings of the top board, and the nozzles are secured by latches locked at the assembly opening.

Particularly, when preparing the first massaging air bag, an air bag with a U-shaped cross section is prepared, two separating strips are sewn onto the air bag, the two separating strips incompletely separate the air bag into a first massaging area located at a front and two second massaging areas located at two sides respectively, and the first massaging area and the second massaging areas are respectively provided with first massaging protrusions.

Particularly, when preparing the second massaging air bag, the second massaging air bag includes a first air bag cell configured to massage a front sole, a second air bag cell configured to massage a middle sole, and a third air bag cell configured to massage a rear sole; the first air bag cell is insulated from the second bag cell, and the second bag cell is insulated from the third bag cell.

Particularly, the first air bag cell, the second air bag cell, and the third air bag cell are arranged horizontally; alternatively, two ends of the second air bag cell are respectively partially arranged under the first air bag cell and under the third air bag cell.

Particularly, when preparing the third massaging bag, two second massaging protrusions are symmetrically arranged on an inner side of the third massaging air bag.

Particularly, the third massaging air bag is separated into two third massaging areas incompletely insulated from each other by a separating strip arranged at a middle part thereof, and the two second massaging protrusions are respectively arranged on the two third massaging areas.

Particularly, when preparing the first massaging air bag, the second massaging air bag, and the third air bag, each of the first massaging air bag, the second massaging air bag, and the third air bag can adopt a single-layer air bag structure, and can also adopt an overlapped and communicated double-layer air bag structure.

Particularly, the preparing step further includes: preparing at least one massaging insole, wherein the massaging insole is provided thereon with a plurality of massaging heads; when the assembly is completed, placing the massing insole onto the second massaging air bag.

Particularly, a plurality of massaging insoles can be prepared, the plurality of massaging insoles can be respectively arranged on the second massaging air bag, and the materials of the plurality of massaging insoles are different; alternatively, the massaging heads of the plurality of massaging insoles are different; further alternatively, both the materials and the massaging heads of the plurality of massaging insoles are different.

In the method for manufacturing a massaging shoe provided by the present invention, the shoe vamp is provided therein with the interlayer; when assembly the shoe vamp and the shoe sole, since there is no massaging air bag in the shoe vamp, the assembly between the shoe vamp and the shoe sole is more convenient and easier, such that the manufacturing process of the massaging shoe is simplified, and the massaging air bag is prevented from being damaged, thereby improving the yield rate; moreover, both assembly and disassembly of the massaging air bag are convenient, and it is also convenient to clean the massaging shoe; if the massaging air bag is broken, the massaging air bag can be directly taken out from the interlayer and replaced, such that it is convenient to repair.

### BRIEF DESCRIPTION OF THE DRAWINGS

FIG. 1 is a flow chart of a method for manufacturing a massaging shoe provided by an embodiment of the present invention;

FIG. 2 is a disassembled view of a massaging shoe provided by an embodiment of the present invention;

FIG. 3 is a rear schematic view of a shoe sole body without a bottom board in an embodiment of the present invention;

FIG. 4 is an unrolled schematic view of a first massaging air bag in an embodiment of the present invention;

FIG. 5 is a side schematic view of the first massaging air bag shown in FIG. 4;

FIG. 6 is a side schematic view of another kind of first massaging air bag in an embodiment of the present invention;

FIG. 7 is an unrolled schematic view of a second massaging air bag in an embodiment of the present invention;

FIG. 8 is a rear schematic view of the second massaging air bag shown in FIG. 7;

FIG. 9 is a side schematic view of the second massaging air bag shown in FIG. 7;

FIG. 10 is an unrolled schematic view of another kind of second massaging air bag in an embodiment of the present invention;

FIG. 11 is a rear schematic view of the second massaging air bag shown in FIG. 10;

FIG. 12 is a side schematic view of the second massaging air bag shown in FIG. 10;

FIG. 13 is an unrolled schematic view of a third massaging air bag in an embodiment of the present invention;

FIG. 14 is a side schematic view of the third massaging air bag shown in FIG. 13; and

FIG. 15 is a side schematic view of another kind of third massaging air bag in an embodiment of the present invention.

### EXPLANATION FOR THE LABEL NUMBERS IN THE DRAWINGS

10-shoe sole; 11-shoe sole body; 12-top board; 121-assembly opening; 13-bottom board; 20-shoe vamp; 30-first massaging air bag; 31-seperating strip; 32-first massaging area; 33-second massaging area; 34-first massaging protrusion; 40-second massaging air bag; 41-first air bag cell; 42-second air bag cell; 43-third air bag cell; 44-nozzle; 50-third massaging air bag; 51-second massaging protrusion; 52-third massaging area; 60-controlling element assembly; 61-air pump; 62-air pipe; 63-controlling valve; 70-latch.

### DETAILED DESCRIPTION OF THE PREFERRED EMBODIMENT

In order to make the purposes, technical solutions, and advantages of the present invention be clearer, the present invention will be further described in detail hereinafter with reference to accompany drawings and embodiments. It should be understood that the specific embodiments described here are only intended to illustrate the present invention, but not to limit the present invention.

It needs to be explained that when one element is referred to as “fixed” or “arranged” on another element, it may be directly located on the another element, or an intermediate element may exist simultaneously. When one element is referred to as “connected” with another element, it may be directly connected with the another element, or an intermediate element may exist simultaneously.

It needs to be further explained that the position terms in embodiments of the present invention, such as left, right, upper, lower, and so on, are only mutually relative concepts or take a normally used status of a product as reference, but should not be considered as having any limitation.

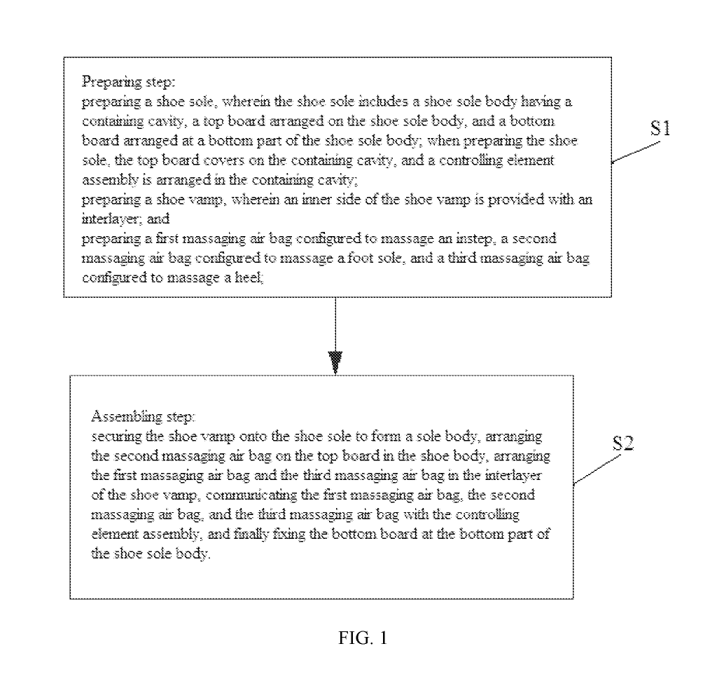

Referring to FIG. 1, a method for manufacturing a massaging shoe provided by an embodiment of the present invention comprises the following steps.

S1: A Preparing Step

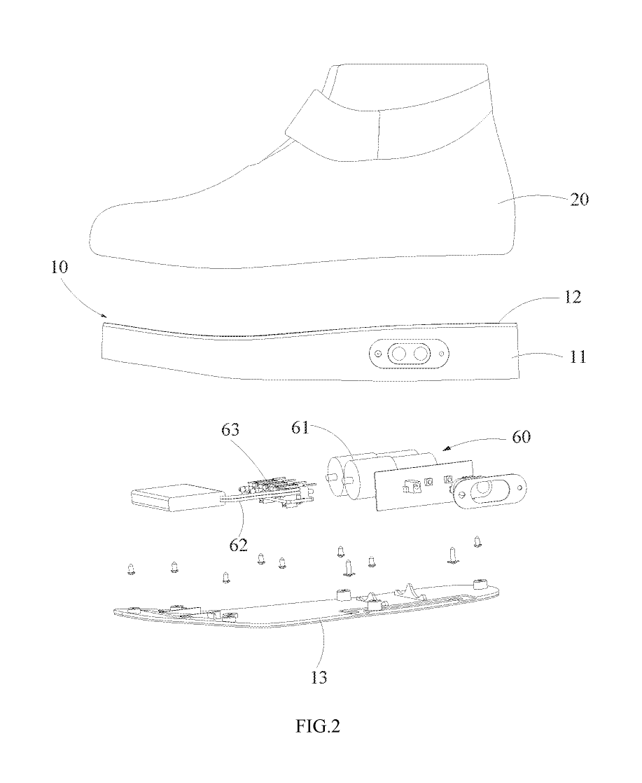

preparing a shoe sole 10, a shoe vamp 20, a first massaging air bag 30, a second massaging air bag 40, a third massaging air bag 50, and a controlling element assembly 60.

Wherein, referring to FIG. 2, when preparing the shoe sole 10, the shoe sole 10 includes a shoe sole body 11 having a containing cavity, a top board 12 covering on the shoe sole body 11, and a bottom board 13 arranged at a bottom part of the shoe sole body 11; the shoe sole body 11, the top board 12, and the bottom board 13 cooperatively form the sealed containing cavity, which is configured to place the controlling element assembly 60. When manufacturing the shoe sole 10, the top board 12 is fixed above the containing cavity of the shoe sole body 11, and the controlling element assembly 60 is mounted in the containing cavity.

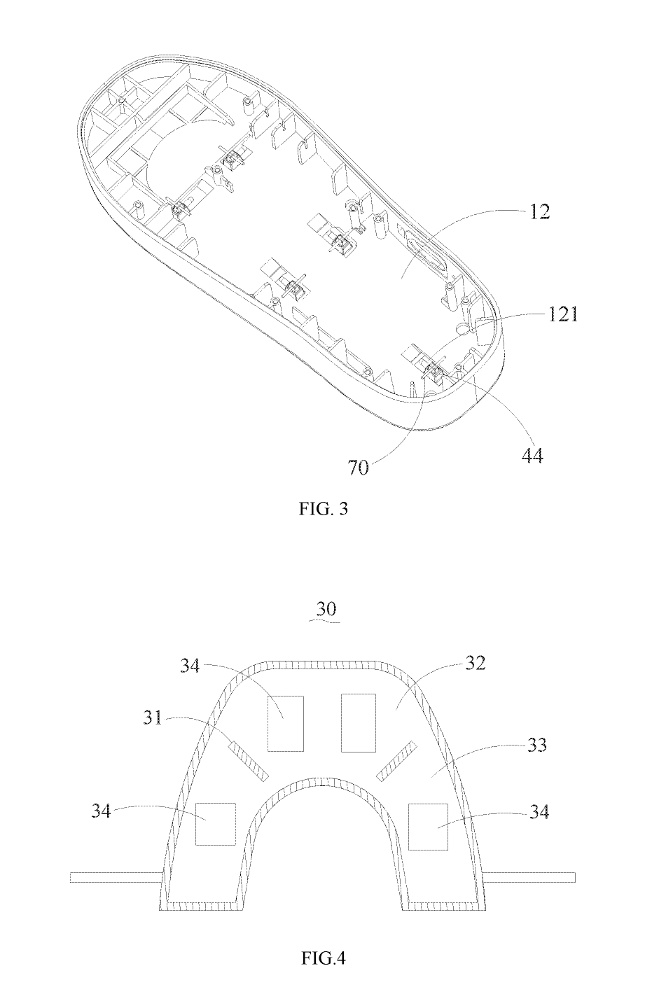

The controlling element assembly 60 includes an air pump 61, an air pipe 62 communicated with the air pump 61, and a controlling valve 63 controlling the air pump 61. Also referring to FIG. 3. when preparing the top board 12, a plurality of assembly openings 121 that can enable nozzles to extend into the containing cavity and communicate with the air pipe 62 are defined in the top board 12.

Referring to FIG. 2 again, when preparing the shoe vamp 20, the structure and appearance of the shoe vamp 20 are identical to that of a shoe vamp 20 of a common shoe. According to requirements, the shoe vamp 20 can be made of various cloths, thereby improving comfort and reducing the weight of the massaging shoe. An inner side of the show vamp 20 is provided with an interlayer (not shown in the drawings), and an opened part of the interlayer is provided with a connecting element that can make the opened part be in an opened status or a closed status. The connecting element can be a zipper, a fastener, or a velcro.

Referring to FIG. 4, when preparing the first massaging air bag 30, an air bag with a U-shaped cross section is prepared, two separating strips 31 are sewn onto the air bag, the two separating strips 31 incompletely separate the air bag into a first massaging area 32 located at a front and two second massaging areas 33 located at two sides respectively, and the first massaging area 32 and the second massaging areas 33 are respectively provided with first massaging protrusions 34. Here, the first massaging protrusions 34 can be small air bag cells, when they are inflated, the air bag cells form small protrusions facilitating massaging. By the arrangement of the first massaging protrusions 34, acupoints on an instep can be targetedly massaged by the first massaging protrusions 34. Moreover, the separating strips 31 are arranged between adjacent massaging areas, such that the air passage between the two adjacent massaging areas become narrower, the first massaging area 32 and the second massaging area 33 are plumper after being inflated, and thus the massaging strength is increased.

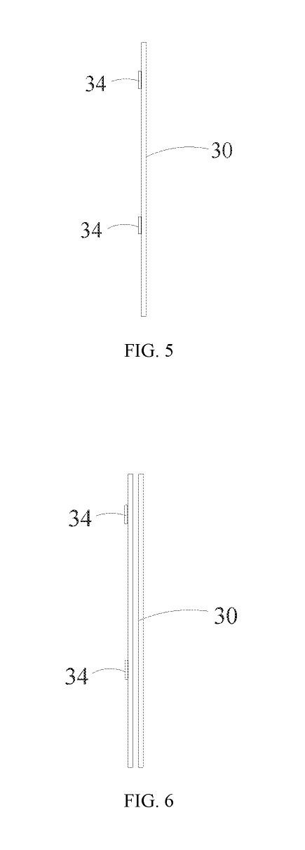

As shown in FIG. 5, in this embodiment, the first massaging air bag 30 is a single-layer air bag structure. Of course, it can also adopt an overlapped and communicated double-layer air bag structure, as shown in FIG. 6.

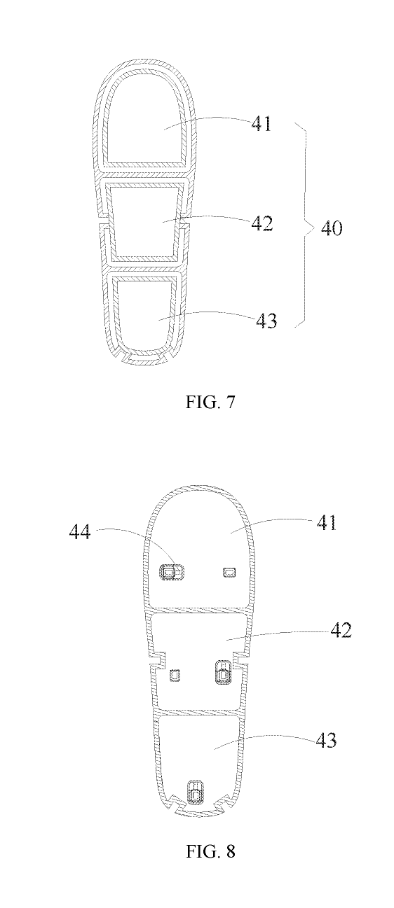

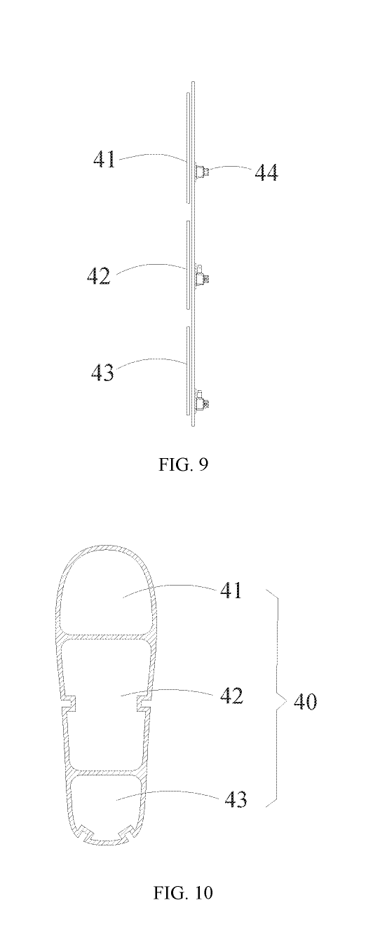

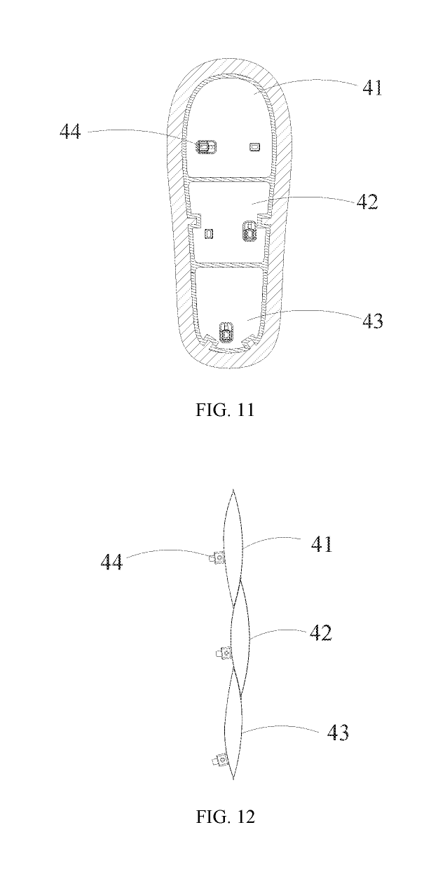

Referring to FIGS. 7-9, when preparing the second massaging air bag 40, a whole structure of the second massaging air bag 40 is substantially similar to that of the top board 12. The second massaging air bag 40 includes a first air bag cell 41 configured to massage a front sole, a second air bag cell 42 configured to massage a middle sole, and a third air bag cell 43 configured to massage a rear sole; the first air bag cell 41 is insulated from the second bag cell 42, and the second bag cell 42 is insulated from the third bag cell 43. Bottom parts of the first air bag cell 41, the second bag cell 42, and the third bag cell 43 are respectively provided with nozzles 44 communicating with an air pipe 62 of the controlling element assembly 60. It can be seen from FIG. 9 that the second massaging air bag 40 is a single-layer air bag, and the first air bag cell 41, the second air bag cell 42, and the third air bag cell 43 are respectively arranged horizontally. As an alternative, the second massaging air bag 40 can also be arranged to be a double-layer structure as shown in FIGS. 10-12, that is, two ends of the second air bag cell 42 are respectively partially arranged under the first air bag cell 41 and under the third air bag cell 43. When being arranged to be a double-layer air bag cell, the second air bag cell 42 has a certain height after being inflated; when the second air bag cell 42 overlaps with the first air bag cell 41 and the third air bag cell 43, the height of these massaging air bag cells are increased, and thus the massaging strength for a foot sole is increased.

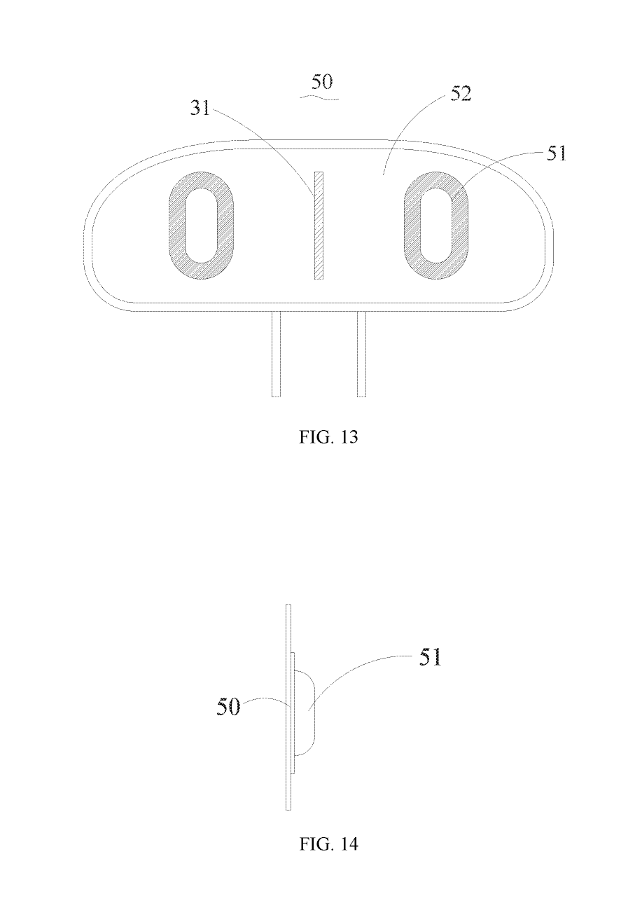

Referring to FIG. 13, when preparing the third massaging air bag 50, two second massaging protrusions 51 are symmetrically arranged on an inner side of the third massaging air bag 50. The second massaging protrusions 51 are made of plastic material. Of course, the second massaging protrusions 51 can also be made of other materials, which have certain rigidities, can ensure the massaging strength when massaging, and will not abrade skin. When the third massaging air bag 50 is inflated/deflated, the third massaging air bag 50 drives the second massaging protrusions to move up and down, thereby simulating a hand of a man to knead a heel. Such massaging effect is better.

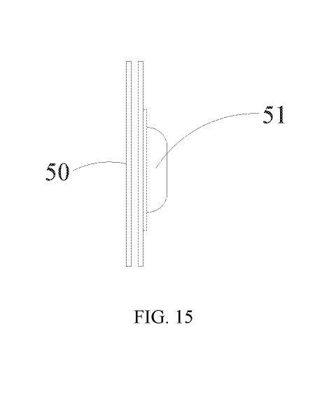

Similarly, the third massaging air bag 50 is separated into two third massaging areas 52 incompletely insulated from each other by a separating strip 31 arranged at a middle part thereof, and the two second massaging protrusions 51 are respectively arranged on the two third massaging areas 52. The function of the strip 31 arranged here is identical to the function of the strip 31 of the first massaging air bag 30, and is not repeated here. In this embodiment, the third massaging air bag 50 is a single-layer air bag structure, and can also be an overlapped and communicated double-layer air bag structure, as shown in FIG. 15.

After the aforesaid preparing step is completed, an assembly for the massaging shoe is performed.

S2: Assembling Step

securing shoe vamp 20 onto the shoe sole 10 to form a shoe body, arranging the second massaging air bag 40 on the top board 12 in the shoe body, arranging the first massaging air bag 30 and the third massaging air bag 50 in the interlayer of the shoe vamp 20, and communicating the first massaging air bag 30, the second massaging air bag 40, and the third massaging air bag 50 with the air pipe 62 of the controlling element assembly 60.

In this step, particularly, the shoe vamp 20 is secured onto the shoe sole 10 using adhesive and by a hot melt method.

Referring to FIG. 3 again, after the first massaging air bag 30, the second massaging air bag 40, and the third massaging air bag 50 are placed into the shoe body, the nozzle 44 of the first massaging air bag 30, the nozzle 44 of the second massaging air bag 40, and the nozzle 44 of the third massaging air bag 50 are respectively inserted into the containing cavity through the assembly opening 121 of the top board 12, and from a bottom part of the containing cavity, the nozzles 44 are secured at the assembly opening 121 by latches 70; finally, the bottom board 13 is fixed at a bottom part of the shoe sole body 11. In a specific assembly, after the nozzles 44 on the massaging air bags are inserted through the assembly opening 121, one of the latches 70 is inserted into an insertion hole of each nozzle 44; meanwhile, the latch 70 transversely locks at the assembly opening 121 so as to prevent each nozzle 44 from separating from the air pipe 62 of the controlling element assembly 60.

As a preferred solution, in the preparing step, at least one massaging insole (not shown in the drawings) can be prepared, wherein the massaging insole is provided thereon with a plurality of massaging heads; when the assembly is completed, the massing insole is placed onto the second massaging air bag 40. By arranging the massaging insole which can be placed on the second massaging air bag 40, the plurality of massaging heads on the massaging insole can massage different acupoints on a foot sole targetedly. According to personal massaging requirements, a user can select placing the massaging insole into the massaging shoe to massage, or directly using the second massaging air bag to massage a foot sole, thereby obtaining different massaging experience. In this way, the structure of the massaging shoe becomes flexible and diverse, and the user can perform massaging adjustments through selections.

As a further solution, a plurality of massaging insoles can be prepared; the plurality of massaging insoles can be respectively placed on the second massaging air bag 40, but they are not placed synchronously. The materials of the plurality of massaging insoles can also be arranged to be different, alternatively, the structures of the massaging heads of the plurality of massaging insoles can be arranged to be different. In this way, massaging experiences brought by insoles with different materials and different rigidities or massaging heads with different structures are different. Of course, the materials and the massaging heads of the plurality of massaging insoles can also be arranged to be different simultaneously.

In the method for manufacturing a massaging shoe of the embodiment of the present invention, the shoe vamp 20 is provided therein with the interlayer; when assembly the shoe vamp 20 and the shoe sole 10, since there is no massaging air bag in the shoe vamp 20, the assembly between the shoe vamp 20 and the shoe sole 10 is more convenient and easier, such that the manufacturing process of the massaging shoe is simplified, and the massaging air bag is prevented from being damaged, thereby improving the yield rate; moreover, both assembly and disassembly of the massaging air bag are convenient, and it is also convenient to clean the massaging shoe; if the massaging air bag is broken, the massaging air bag can be directly taken out from the interlayer and replaced, such that it is convenient to repair.

The above contents are only preferred embodiments of the present invention, and are not intended to limit the present invention. Any modification, equivalent replacement or improvement made within the spirit and principle of the present invention should be included in the protection scope of the present invention.

1. A method for manufacturing a massaging shoe comprising the following steps:
a preparing step:
preparing a shoe sole, wherein the shoe sole includes a shoe sole body having a containing cavity, a top board arranged on the shoe sole body, and a bottom board arranged at a bottom part of the shoe sole body; when preparing the shoe sole, the top board covers on the containing cavity, and a controlling element assembly is arranged in the containing cavity;
preparing a shoe vamp, wherein an inner side of the shoe vamp is provided with an interlayer; and
preparing a first massaging air bag configured to massage an instep, a second massaging air bag configured to massage a foot sole, and a third massaging air bag configured to massage a heel;
an assembling step:
securing the shoe vamp onto the shoe sole to form a sole body, arranging the second massaging air bag on the top board in the shoe body, arranging the first massaging air bag and the third massaging air bag in the interlayer of the shoe vamp, communicating the first massaging air bag, the second massaging air bag, and the third massaging air bag with the controlling element assembly, and finally fixing the bottom board at the bottom part of the shoe sole body.

2. The method for manufacturing a massaging shoe according to claim 1, wherein when preparing the shoe sole, the top board is fixed above the containing cavity of the shoe sole body firstly, and the controlling element assembly is mounted in the containing cavity; in the assembling step, after the first massaging air bag, the second massaging air bag, and the third massaging air bag are communicated with the controlling element assembly, the bottom board is fixed at the bottom part of the containing cavity.

3. The method for manufacturing a massaging shoe according to claim 1, wherein when preparing the shoe vamp, a connecting element enabling an opening of the interlayer to be in an opened status or a closed status is arranged at the opening of the interlayer.

4. The method for manufacturing a massaging shoe according to claim 3, wherein the connecting element is any one of a zipper, a fastener, and a velcro.

5. The method for manufacturing a massaging shoe according to claim 1, wherein the controlling element assembly includes an air pump, an air pipe communicated with the air pump, and a controlling valve controlling the air pump; when preparing the top board, a plurality of assembly openings enabling nozzles to extend into the containing cavity and communicate with the air pipe are arranged on the top board.

6. The method for manufacturing a massaging shoe according to claim 1, wherein in the assembling step, the shoe vamp is secured onto the shoe sole using adhesive and by a hot melt method.

7. The method for manufacturing a massaging shoe according to claim 5, wherein in the assembling step, after the first massaging air bag, the second massaging air bag, and the third massaging air bag are arranged in the shoe body, a nozzle of the first massaging air bag, a nozzle of the second massaging air bag, and a nozzle of the third massaging air bag are respectively inserted into the containing cavity through the assembly openings of the top board, and the nozzles are secured by latches locked at the assembly opening.

8. The method for manufacturing a massaging shoe according to claim 1, wherein when preparing the first massaging air bag, an air bag with a U-shaped cross section is prepared, two separating strips are sewn onto the air bag, the two separating strips incompletely separate the air bag into a first massaging area located at a front and two second massaging areas located at two sides respectively, and the first massaging area and the second massaging areas are respectively provided with first massaging protrusions.

9. The method for manufacturing a massaging shoe according to claim 1, wherein when preparing the second massaging air bag, the second massaging air bag includes a first air bag cell configured to massage a front sole, a second air bag cell configured to massage a middle sole, and a third air bag cell configured to massage a rear sole; the first air bag cell is insulated from the second bag cell, and the second bag cell is insulated from the third bag cell.

10. The method for manufacturing a massaging shoe according to claim 9, wherein the first air bag cell, the second air bag cell, and the third air bag cell are arranged horizontally, or two ends of the second air bag cell are respectively partially arranged under the first air bag cell and under the third air bag cell.

11. The method for manufacturing a massaging shoe according to claim 1, wherein when preparing the third massaging bag, two second massaging protrusions are symmetrically arranged on an inner side of the third massaging air bag.

12. The method for manufacturing a massaging shoe according to claim 11, wherein the third massaging air bag is separated into two third massaging areas incompletely insulated from each other by a separating strip arranged at a middle part thereof, and the two second massaging protrusions are respectively arranged on the two third massaging areas.

13. The method for manufacturing a massaging shoe according to claim 1, wherein when preparing the first massaging air bag, the second massaging air bag, and the third air bag, each of the first massaging air bag, the second massaging air bag, and the third air bag can adopt a single-layer air bag structure, and can also adopt an overlapped and communicated double-layer air bag structure.

14. The method for manufacturing a massaging shoe according to claim 1, wherein the preparing step further includes: preparing at least one massaging insole, wherein the massaging insole is provided thereon with a plurality of massaging heads; when the assembly is completed, placing the massing insole onto the second massaging air bag.

15. The method for manufacturing a massaging shoe according to claim 14, wherein a plurality of massaging insoles are prepared, the plurality of massaging insoles can be respectively arranged on the second massaging air bag, and the materials of the plurality of massaging insoles are different, or the massaging heads of the plurality of massaging insoles are different, or both the materials and the massaging heads of the plurality of massaging insoles are different.
